(19) United States
(12) Patent Application Publication
(10) Pub. No.: US 2008/0265037 A1
(43) Pub. Date: Oct. 30, 2008

(54) Optical Scanning Device

(75) Inventors: Gert T'Hooft, Eindhoven (NL); Frank Jeroen Pieter Schuurmans, Eindhoven (NL); Bernardus Hendrikus Wilhelmus Hendriks, Eindhoven (NL); Mohammed Meftah, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,609

(22) PCT Filed: Nov. 24, 2006
(86) PCT No.: PCT/IB2006/054418

§ 371 Date: May 22, 2008

(30) Foreign Application Priority Data
Nov. 30, 2005 (EP) 05300980.9

(51) Int. Cl. G06K 7/10

(52) U.S. Cl. 235/470

(57) ABSTRACT

An optical scanning device for scanning an optical record carrier. The optical scanning device includes: a radiation source system (661; 761); an optical element (1; 101; 201; 301) comprising a first fluid (A) and a second fluid (B; C) separated from each other by a fluid meniscus (16; 116, 138; 216; 316) having an adjustable configuration; and a control system (20; 120; 220; 320) arranged to adjust the fluid meniscus configuration to introduce a first type of wavefront modification. The first type of wavefront modification causes the radiation beam to be redirected from an input radiation beam path (2; 102; 244; 348) onto one of a plurality of output radiation beam paths (24, 26; 140; 246; 350) which each have a different angular displacement (α, β, γ, δ, ∈) from the input radiation beam path. The control system is further arranged to adjust the fluid meniscus configuration to introduce a second type of wavefront modification. The second type of wavefront modification is arranged to compensate a wavefront aberration of the radiation beam, the compensated wavefront aberration being adjusted in accordance with the angular displacement.

### FIELD OF THE INVENTION

The present invention relates to an optical scanning device for scanning an optical record carrier, in particular for scanning a holographic optical record carrier.

### BACKGROUND OF THE INVENTION

Devices for reading data from and writing data to an optical record carrier, such as a compact disc (CD), a digital-versatile-disc (DVD), or a holographic optical record carrier, generally contain components for manipulating a radiation beam for irradiation of the optical record carrier. Such manipulation may involve, for example, changing a direction of the beam.

It is important that reading or writing of data on the carrier is as accurate as possible, to avoid errors in the data. Often, when scanning the optical record carrier, an aberration, such as a spherical aberration, is introduced into the beam by a device component, or by a part of the optical record carrier itself. These aberrations can lead to the introduction of data errors into a data signal carried by the beam.

Systems are known for reducing aberrations in a beam for scanning optical record carriers. International patent application WO2004/102251 describes an adjustable mirror having a fluid meniscus, which may be used in an optical scanning device described in U.S. Pat. No. 5,880,896. The mirror deflects a scanning beam along a single radiation beam path and, by adjusting a configuration of the meniscus, applies a spherical aberration to the beam which cancels a spherical aberration caused by a thickness of a substrate of the record carrier.

### SUMMARY OF THE INVENTION

It is an object of the present invention to reduce aberrations of a radiation beam for scanning an optical record carrier.

In accordance with a first aspect of the present invention, there is provided an optical scanning device for scanning an optical record carrier, wherein said optical scanning device includes:

a) a radiation source system arranged to emit a radiation beam for irradiation of said optical record carrier;

b) an optical element comprising a first fluid and a second fluid separated from each other by a fluid meniscus having an adjustable configuration; and

c) a control system arranged to adjust said fluid meniscus configuration to introduce a first type of wavefront modification, said first type of wavefront modification causing said radiation beam to be redirected from an input radiation beam path onto one of a plurality of output radiation beam paths which each have a different angular displacement from said input radiation beam path,

characterised in that said control system is further arranged to adjust said fluid meniscus configuration to introduce a second type of wavefront modification, said second type of wavefront modification being arranged to compensate a wavefront aberration of the radiation beam, the compensated wavefront aberration being adjusted in accordance with said angular displacement.

The optical element, by introducing the first type of wavefront modification, redirects the radiation beam onto one output radiation beam path and thus controls a direction of propagation of the beam through the optical scanning device. Further, the optical element introduces a second type of wavefront modification which is in accordance with the angular displacement, thus controlling a form of the second type of wavefront modification in dependence on a selected output radiation path.

The radiation beam can be directed onto different output radiation beam paths and the second type of wavefront modification adjusted accordingly. Thus, when scanning the optical record carrier, the second type of wavefront modification is dynamically adjusted in response to redirection of the beam onto a different output-path.

Redirection of the beam changes an angle of incidence of the beam on optical components of the device, causing the beam to follow a non-optimum path through the components. Redirection may also change an angle of incidence of the beam upon a substrate of an optical record carrier. As a consequence, a wavefront aberration may be introduced into the beam which can, for example, produce errors in data being written onto, and/or read from, the optical record carrier. By introducing a compensatory second type of wavefront modification in accordance with the angular displacement, the optical element minimises such wavefront aberrations and thus minimises any errors in reading or writing data.

The optical element has a low power consumption, a rapid switching time of the meniscus configuration, and can be constructed inexpensively according to a compact design. The present invention provides apparatus for redirecting a radiation beam, and for introducing a second type of wavefront modification, in a simple and efficient manner. Moreover, adjustment of the fluid meniscus configuration causes minimal wear and tear of the element; thus, the optical element is reliable and durable.

The term angular displacement, used herein, is an angular separation between the input radiation beam path (possibly in an extended form, as will become apparent later), and a selected output radiation beam path. The angular displacement is given as an angular value taken in a plane of redirection of the radiation beam. Positive and negative angular displacements may be possible and the sum of a maximum positive angular displacement and a maximum negative angular displacement gives a maximum possible range of the angular displacement.

The term scanning, used herein, should be taken to include reading data from the optical record carrier, and/or writing data to the optical record carrier. In accordance with preferred embodiments of the invention, the wavefront aberration includes at least one of astigmatism, spherical aberration and coma. The optical element can, in this way, compensate a variety of different wavefront aberrations.

The term compensates, used herein, should be taken to mean changing the wavefront of the radiation beam to reduce a wavefront aberration of the radiation beam, whether the wavefront aberration already exists in the beam or whether it may subsequently be introduced.

Preferably, the optical scanning device is arranged to scan a holographic optical record carrier with at least one region for storing a data book.

In an angle multiplexing technique for scanning the holographic optical record carrier, a reference radiation beam can be redirected along different output radiation paths by the optical element. Each output path corresponds with a different data page of the data book. Adjustment of the second type of wavefront modification according to the selected output path allows data errors which arise during scanning to be minimised.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an optical element in a first configuration, in accordance with an embodiment of the present invention.

FIG. 2 shows schematically an electrode configuration in accordance with an embodiment of the present invention.

FIG. 3 shows schematically an optical element in a second configuration, in accordance with an embodiment of the present invention.

FIGS. 4 to 6 show schematically optical elements in accordance with further embodiments of the present invention.

FIGS. 7 and 8 show schematically electrode configurations in accordance with embodiments of the present invention.

FIG. 9 shows schematically an optical scanning device in accordance with an embodiment of the present invention.

FIG. 10 shows schematically a radiation beam passing through parts of an optical scanning device in accordance with embodiments of the present invention.

FIG. 11 shows schematically an optical scanning device in accordance with a different embodiment of the present invention.

### DETAILED DESCRIPTION OF THE INVENTION

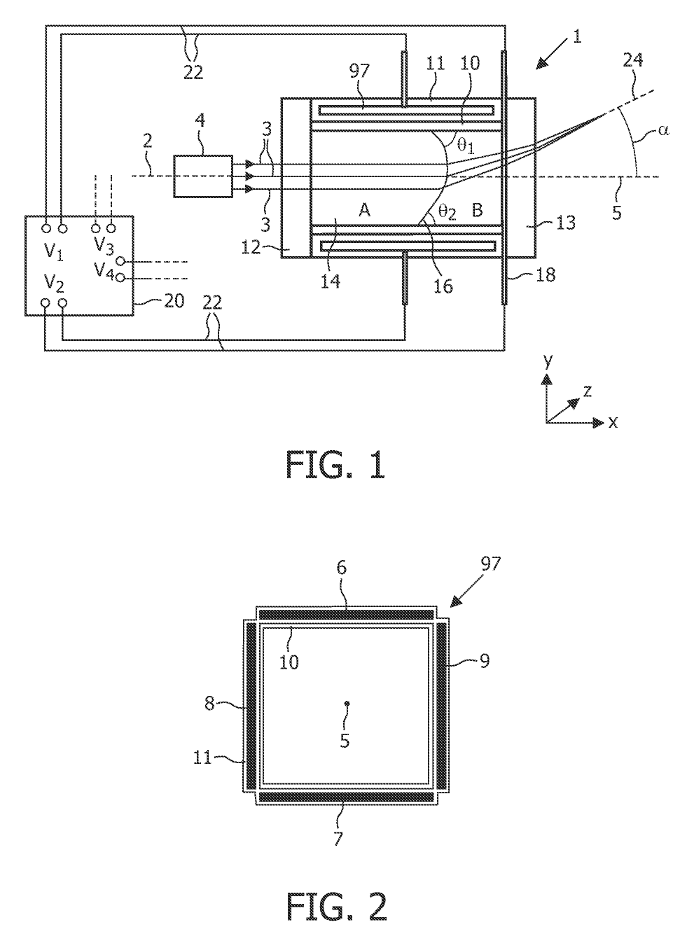

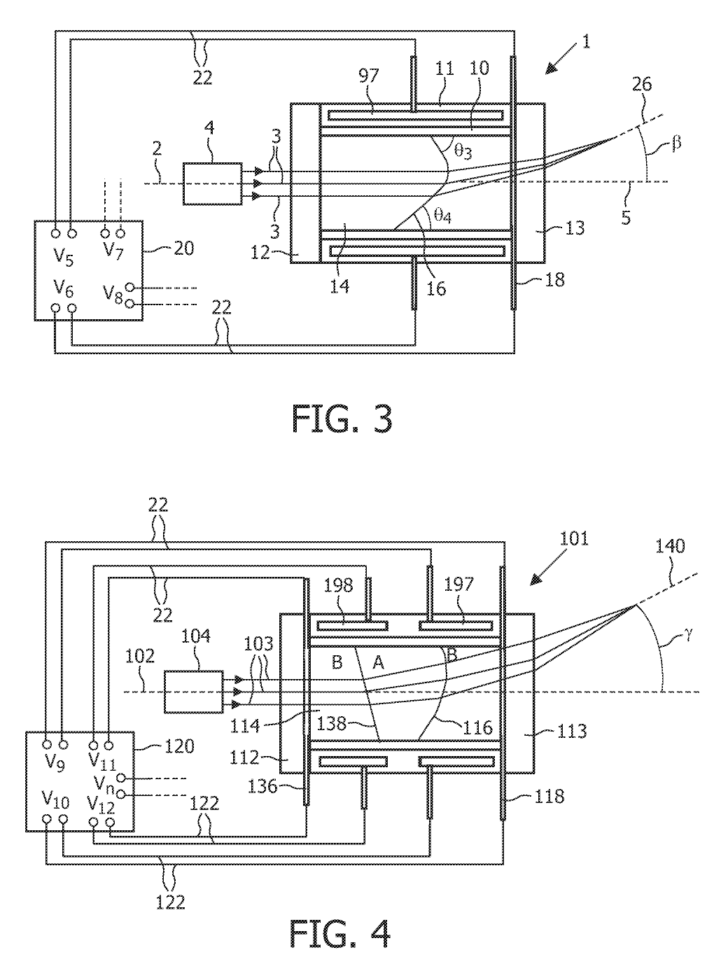

FIGS. 1 and 3 show schematically an optical element 1. Additional details of the optical element 1 are incorporated herein by way of reference to international patent application WO 2004/051323.

Referring to FIG. 1, the optical element 1 has an input radiation beam path 2 for a radiation beam, indicated in FIG. 1 by radiation rays 3, to pass along so as to enter the optical element 1. The radiation beam is emitted by a radiation source system 4, such as a laser. The optical element 1 comprises a plurality of electrodes including a configuration of a first set 97 of segment electrodes which are arranged about an extended form 5 of the input radiation beam path 2, the input path 2 being linearly extended through the optical element 1 as shown in FIG. 1.

FIG. 2 shows a cross-section of the configuration of the first set 97 of electrodes, viewed from one end of the electrodes, which is taken perpendicular the extended input radiation beam path 5 and is suitable for producing anamorphic meniscus lens shapes, as will be described in further detail later. The first set 97 of electrodes includes four segment electrodes 6, 7, 8, 9 which are each rectangular and planar and which are spaced about the extended input radiation beam path 5 in a square formation with their longitudinal edges parallel, thus forming a square enclosure. Opposite ones of the segment electrodes 6, 7, 8, 9 are arranged in pairs; thus one segment electrode 6 and the opposite segment electrode 7 are arranged as a first pair, and another segment electrode 8 and the opposite segment electrode 9 form a second pair. At least the inner surface of the segment electrodes 6, 7, 8, 9 is covered with a continuous, uniform thickness, electrically insulating, fluid contact layer 10, formed for example of Teflon™ AF1600, which constrains the meniscus edge, as will become apparent later. In this embodiment each surface of each segment electrode 6, 7, 8, 9 is covered with an insulating layer 11 which may also be formed of Teflon™ AF1600 or may, alternatively, be formed of parylene.

With reference to FIG. 1, the electrodes 6, 7, 8, 9 of the first set 97 are arranged to form side walls of a fluid chamber 14 which is sealed to prevent leakage of fluid from the chamber. A transparent front element 12 forms part of one end wall of the fluid chamber 14 and a transparent back element 13 forms part of another end wall of the fluid chamber 14.

The fluid chamber 14 contains a first fluid which is an electrically insulating first liquid A, such as a silicone oil or an alkane, with a selected refractive index; and a second fluid which is an electrically conducting second liquid B, such as water containing a salt solution, with a different refractive index. The first and second fluids are immiscible with each other and are separated from each other by a fluid meniscus 16 having an adjustable configuration which, as shown in FIG. 1, has a curvature which is not rotationally symmetric about the extended input radiation beam path 5. The two liquids A, B are preferably arranged to have an equal density so that the configuration of the meniscus 16 may be controlled independently of an orientation of the optical element 1.

The plurality of electrodes further includes a first end electrode 18, which is annular or optically transparent to allow radiation beams to pass through the first end electrode 18, and is arranged at one end of the fluid chamber 14, in this case, adjacent the back element 13. The first end electrode 18 is arranged with at least one part in the fluid chamber 14 such that the electrode acts on the second fluid B.

A control system 20 is arranged to determine the configuration of the fluid meniscus 16 by application of a voltage to at least one electrode 6, 7, 8, 9, of the first set 97. The control system 20 is electrically connected 22 to each of the segment electrodes, 6, 7, 8, 9 and to the first end electrode 18, and is arranged, whilst applying the appropriate voltage also to the first end electrode 18, to apply a first voltage V₁ to one electrode of the first pair, to apply a second voltage V₂ to the other electrode of the first pair, and to apply a further voltage V₃, V₄ to each of the electrodes of the second pair. The voltage applied to at least one of the segment electrodes 6, 7, 8, 9 may be the same as, or different to, the voltage applied to at least one other of the segment electrodes 6, 7, 8, 9. Measurement of a capacity of each electrode allows the current meniscus configuration to be identified. These measurements provide feedback to the control system 20, thus allowing the control system 20 to accurately control the fluid meniscus configuration.

Adjustment of the voltages applied by the control system 20 adjusts, and thus controls, the meniscus configuration. The applied voltages apply electrowetting forces to the fluids A, B, which determine a wettability, by the second fluid B, of the fluid contact layer 10 across each of the segment electrodes 6, 7, 8, 9. This wettability determines a contact angle of the meniscus 16 at a three phase line (the line of contact between the fluid contact layer 10 and the two liquids A, B), for each segment electrode 6, 7, 8, 9.

By adjustment of the applied voltages, the meniscus configuration can be adjusted to obtain different fluid meniscus configurations. Meniscus configurations with an aspherical curvature are achievable, which may or may not be rotationally symmetric about the extended input radiation beam path 5.

An anamorphic meniscus configuration may also be obtained which can act as an anamorphic lens by generally focusing incoming light rays at two focal lines which are generally orthogonal and axially separated. An anamorphic lens exhibits a different value of focal power or magnification in two generally orthogonal axes, one of which is referred to as the cylindrical axis, arranged in a plane perpendicular to the extended input path 5. These focal properties characterise the optical condition ‘astigmatism’. Anamorphic lens shapes include those of an approximately cylindrical and approximately sphero-cylindrical nature.

Meniscus configurations are possible which have a convex or concave curvature when viewed from the front element 12. Alternatively, planar meniscus configurations may be obtained.

The configuration of the fluid meniscus 16 may be a combination of meniscus configurations described previously, for example the fluid meniscus 16 may have a configuration which is a combination of a planar and an anamorphic configuration.

The optical element 1 is used to manipulate a radiation beam by adjusting the meniscus configuration to modify the wavefront of the beam to, for example, redirect the radiation beam and/or introduce a second type of wavefront modification into the radiation beam. Adjustment of the fluid meniscus configuration can control such a manipulation.

For redirection of the radiation beam, the optical element 1 is arranged to introduce a first type of wavefront modification into the beam to redirect a radiation beam entering the optical element 1 from the input radiation beam path 2 onto one of a plurality of output radiation beam paths which each have a different angular displacement from the input path. Appropriate adjustment of the fluid meniscus configuration redirects a radiation beam onto different ones of a plurality of output radiation beam paths, as will be described below in further detail. The optical element 1 redirects a radiation beam by refraction of the beam at the meniscus 16 and also by refraction at an external surface of the back element 13. Other parts of the optical element 1 may also refract the beam.

With reference to FIG. 1, the voltage V₁ applied to the one electrode of the first pair determines a first contact angle θ₁, and the voltage V₂ applied to the other electrode of the first pair determines a second contact angle θ₂ which is, in this example, smaller than the first contact angle θ₁. The voltages applied to the electrodes of the second pair determine further contact angles. This combination of applied voltages determines a particular fluid meniscus configuration which is, in this example, a combination of a planar configuration and an anamorphic configuration. The input radiation beam is redirected in an X-Y plane, defined by orthogonal axes x, y, z, from the input radiation beam path 2 onto a first output radiation beam path 24. The first output radiation beam path 24 has a first angular displacement α from the extended input radiation beam path 5. Further, the meniscus 16 introduces a second type of wavefront modification into the beam so as to add astigmatism into the beam.

Each contact angle has a smallest obtainable value of approximately 60°. If liquid A has a refractive index of n=1.6 and liquid B has a refractive index of n=1.33, the maximum positive angular displacement is approximately +90 and the maximum negative angular displacement is approximately −9°, so that a maximum range of the angular displacement is approximately 18°.

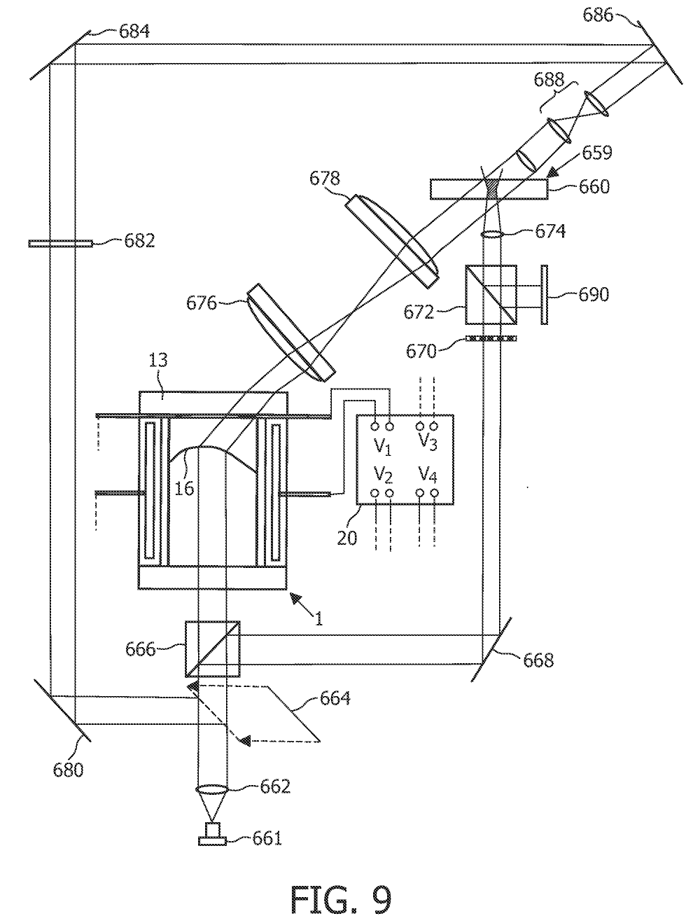

The optical element, by use of the meniscus 16, introduces the first type of wavefront modification to redirect the beam according to a desired angular displacement, in combination with the second type of wavefront modification to provide a desired compensation of the wavefront aberration. To achieve this, the control system 20 calculates the required meniscus configuration and adjusts the meniscus configuration accordingly, for example, in accordance with the adjustment of the meniscus configuration described with reference to any of FIGS. 9, 10 and 11.

Referring now to FIG. 3, which shows the optical element 1 described previously redirecting a beam according to a different angular displacement, the voltages applied to the electrodes are adjusted by the control system 20 so that a different voltage V₅ is applied to the one electrode of the first pair, a different voltage V₆ is applied to the other electrode of the first pair, and a further voltage V₇, V₈ is applied to each of the other electrodes. The different applied voltages determine different contact angles, including a third contact angle θ₃ with the one electrode of the first pair and a fourth contact angle θ₄ with the other electrode of the first pair. Again, the meniscus configuration is a combination of a planar configuration and an anamorphic configuration. The radiation beam is redirected along a different output radiation beam path 26 which has a different angular displacement β from the extended input radiation beam path 5. In this example the first angular displacement α is greater than the second angular displacement β. The meniscus 16 also introduces a different second type of wavefront modification which adds astigmatism into the beam. The control system 20 may adjust the meniscus configuration so that the beam is redirected along different output radiation beam paths with different angular displacements. In addition, the control system 20 is arranged to adjust the second type of wavefront modification introduced into the beam in accordance with the particular output radiation beam path that the beam is redirected onto. For example, if the beam is redirected onto a first output radiation beam path, with a particular angular displacement, a particular second type of wavefront modification is introduced into the beam. If the beam is subsequently redirected onto a different output radiation beam path, with a different angular displacement, a different second type of wavefront modification is introduced. In this way the control system is arranged to adjust the second type of wavefront modification in accordance with the angular displacement.

In one example, the control system 20 calculates the required meniscus configuration and adjusts the meniscus configuration in accordance with the adjustment of the meniscus configuration described with reference to any of FIGS. 9, 10 and 11.

FIGS. 1 and 3 show the rays 3 of the beam being focused by the optical element 1. The optical element may, alternatively, change a vergence of the beam so that the output beam has divergent or parallel beam rays.

FIG. 4 shows an optical element 101, in accordance with a further embodiment of the present invention, with similar features to those of the optical element 1 described with reference to FIGS. 1 and 3. Such features are indicated herein using the same reference numerals, incremented by 100, and corresponding descriptions should be taken to apply here also.

Additional details of the optical element 101 are incorporated herein by way of reference to international patent application WO 2004/051323.

The plurality of electrodes of the optical element 101 comprises a configuration of a second set 198 of segment electrodes similar to the first set 197 described with reference to FIG. 2. The plurality of electrodes further comprises a second end electrode 136 which is similar in construction to the first end electrode 118. The four electrodes of the second set 198 are electrically insulated from each other, from the first set 197 of electrodes, and from the end electrodes 118, 136. In this embodiment the second end electrode 136 and the front element 112 each form part of one end wall of the fluid chamber 114 and the back element 113 and the first end electrode 118 each form part of another end wall of the fluid chamber 114. The electrodes of the first and second sets 197, 198 form side walls of the fluid chamber 114.

The fluid chamber 114 holds a third fluid, which in this embodiment is liquid B described previously, and which lies in contact with the second end electrode 136 and is separated from liquid A by a second fluid meniscus 138. The second end electrode 136 is positioned between the front element 112 and the fluid chamber 114 so as to be partly in contact with the third fluid. The skilled person will appreciate that the third fluid may comprise a different liquid than liquid B.

The control system 120 is electrically connected to each end electrode 118, 136 and to each electrode of the first and second sets 197, 198, and is arranged to apply a voltage to each electrode. A voltage V₉ is applied to one electrode of the first set 197 and a voltage V₁₀ is applied to an opposing electrode of the first set 197, in addition to a further voltage Vₙ being applied to at least one of the other electrodes of the first set 197, in order to adjust the configuration of the meniscus 116. The control system 120 applies a voltage V₁₁ to one electrode of the second set 198 and applies a voltage V₁₂ to an opposing electrode of the second set 198, in addition to applying a further voltage Vₙ to further of the electrodes of the second set 198, in order to adjust the configuration of the second meniscus 138 in a similar manner to the fluid meniscus adjustment described previously. An appropriate voltage is also applied to the end electrodes 118, 136.

As an example, the control system 120, for at least one of the two fluid menisci 116, 138, calculates the required meniscus configuration and adjusts the meniscus configuration in accordance with the adjustment of the meniscus configuration described with reference to any of FIGS. 9, 10 and 11.

Adjustment of the configuration of both the meniscus 116 and the second fluid meniscus 138 allows the radiation beam to be manipulated with greater flexibility than the optical element 1 described previously. For example, the beam can be redirected onto output paths with a greater maximum range of angular displacements. In this example the beam is redirected along an output radiation beam path 140 with a third angular displacement 7, which is greater than the first and second angular displacements α, β.

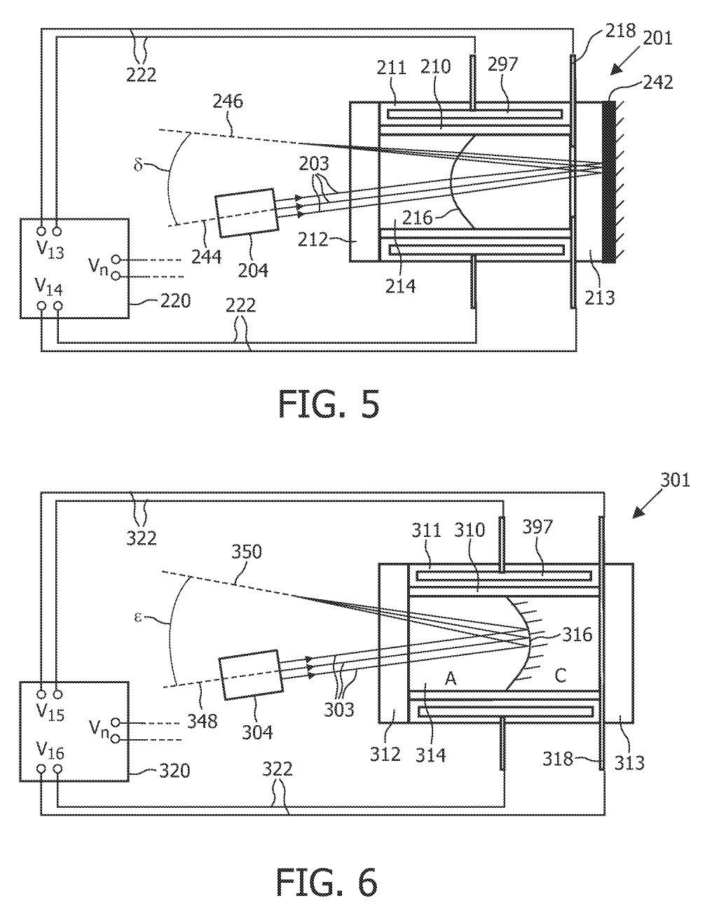

For previous embodiments, the extended input radiation beam path coincides with a central longitudinal axis of the fluid chamber; however, in further embodiments, including those described using FIGS. 5 and 6, the extended input radiation beam path may alternatively pass through the optical element along a non-central longitudinal axis, so that the input path is not perpendicular the external surface of the front element via which the radiation beam enters the optical element.

FIG. 5 shows a further optical element 201 in accordance with embodiments of the present invention. Features of the optical element 201 are similar to features of the optical element 1 described with reference to FIGS. 1 and 3. Such features are indicated herein using the same reference numerals, incremented by 200, and corresponding descriptions should be taken to apply here also. Further details of the optical element 201 are incorporated herein by way of reference to international patent application WO 2004/102251.

A reflective surface 242 comprising, for example, a metal coating of aluminium, gold or silver, or an appropriate dielectric coating is attached to an external surface of the back element 213. The control system 220 applies a voltage V₁₃ to one electrode of the first set 297, applies a voltage V₁₄ to an opposing electrode of the first set 297 and may apply a further voltage Vₙ to at least one of the other electrodes of the first set 297, in addition to the first end electrode 218.

A radiation beam enters the optical element 201 through the front element 214 along the input path 244 and is redirected, by reflection of the radiation beam by the reflective surface 242, onto an output radiation beam path 246 which has an angular displacement δ from the input path 244. The redirected beam exits the optical element 201 via the front element 212. The reflective surface 242 therefore provides a mirror function and the configuration of the meniscus 216, as determined by the control system 220, selects which output radiation beam path the beam is redirected onto. The meniscus configuration also introduces a second type of wavefront modification into the radiation beam.

In an example, the control system 220 calculates the required meniscus configuration and adjusts the meniscus configuration in accordance with the adjustment of the meniscus configuration described with reference to any of FIGS. 9, 10 and 11.

FIG. 6 shows a further optical element 301 in accordance with embodiments of the present invention. Features of the optical element 301 are similar to features of the optical element 1 described with reference to FIGS. 1 and 3. Such features are indicated herein using the same reference numerals, incremented by 300, and corresponding descriptions should be taken to apply here also.

In this embodiment, the second fluid is not liquid B but is a liquid C which is immiscible with the first fluid and causes the meniscus 316 to reflect a radiation beam. In one example, liquid C is mercury. In an alternative example, liquid C is a suspension of metallic particles, which include for example, silver particles, which aggregate at the meniscus 316 to form a reflective surface at the meniscus 316. Further details in this respect of the use of metallic particles to form a metal liquid-like film (MELLF) at the interface between two liquids, or on an external surface of a liquid, are included herein by way of reference Hélène Yockell—Lelièvre, Ermano F. Borra, Anna M. Ritcey, Lande Vieira da Silva, “Optical Tests of Nanoengineered Liquid Mirrors”, Applied Optics 42 (2003) p. 1882.

The control system 320 applies a voltage V₁₅ to one electrode of the first set 397, applies a voltage V₁₆ to an opposing electrode of the first set 397 and may apply a further voltage Vₙ to at least one of the other electrodes of the first set 397 and to the first end electrode 318, to determine the meniscus configuration. A radiation beam enters the optical element 301 through the front element 312 along the input path 348 and is redirected, by reflection of the beam by the reflective surface provided by liquid C at the meniscus 316, onto an output radiation beam path 350 which has an angular displacement ∈ from the input path 348. The redirected beam exits the optical element 301 via the front element 312. The control system 320, by adjustment of the meniscus configuration, controls the mirror function provided by the meniscus 316 and thus selects which output path the beam is redirected onto. The meniscus configuration also introduces a second type of wavefront modification into the radiation beam.

In one example, the control system 320 calculates the required meniscus configuration and adjusts the meniscus configuration in accordance with the adjustment of the meniscus configuration described with reference to any of FIGS. 9, 10 and 11.

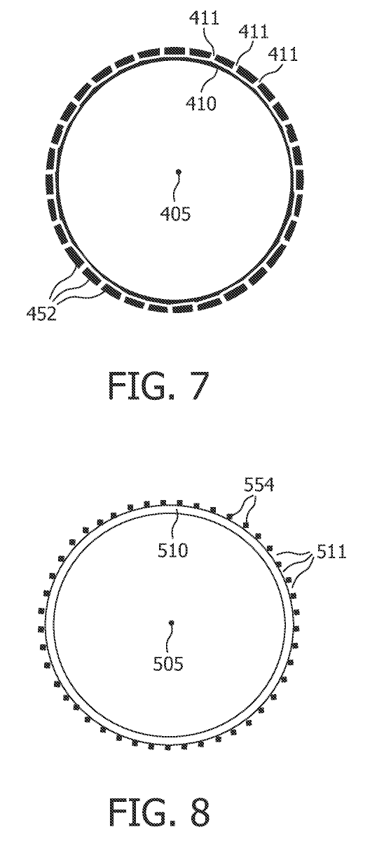

With reference to FIGS. 7 and 8, alternative sets of segment electrodes will now be described. It will be appreciated that the set of electrodes of any optical element described previously may be substituted with the set of electrodes described using either FIG. 7 or FIG. 8.

FIG. 7 shows a cross-section of an alternative configuration of a set of segment electrodes. Features of this configuration of electrodes are similar to the configuration of the first set 397 described using FIG. 2. Such features are indicated using the same reference numerals, incremented by 400; corresponding descriptions should be taken to apply here also. FIG. 7 is a cross section view taken from one end of the segment electrodes, and is perpendicular the extended input radiation beam path 405.

The segment electrodes 452 are each electrically connected to the control system of the optical element. In this embodiment there are thirty one individual segment electrodes 452; however, there may, alternatively, be more than, or less than thirty one electrodes. By application of a voltage to different of the segment electrodes 452 the configuration of the meniscus can be adjusted in the manner described previously. The larger number of segment electrodes 452 of this configuration allows a greater variety of meniscus configurations to be obtained. A more accurate manipulation of the radiation beam may also be provided, for example by introducing a second type of wavefront modification with reduced optical aberrations.

Further configurations of a set of segment electrodes of the optical element are envisaged. FIG. 8 shows a further exemplary configuration of a set of segment electrodes. Features of this set of electrodes are similar to the set of electrodes described using FIG. 2. Such features are indicated using the same reference numerals, incremented by 500; corresponding descriptions should be taken to apply here also. FIG. 8 is a cross section view taken from one end of segment electrodes 554 and is perpendicular the extended input radiation beam path 505. In this example, a thickness of the insulating layer 511, taken in a direction from one electrode 554 to an adjacent electrode 554, is greater than a thickness of each electrode 554, taken in a direction from one inter-electrode part of the insulating layer 511 to an adjacent inter-electrode part of the insulating layer 511. This arrangement of thicknesses reduces discontinuous variation of the contact angles along the edge of the fluid meniscus and therefore reduces any optical aberrations introduced by the meniscus into the radiation beam.

FIG. 9 shows an optical scanning device for scanning an optical record carrier. It should be noted that FIG. 9 is schematic and is not drawn to scale. In this embodiment the optical scanning device is arranged to scan a holographic optical record carrier 659 including a holographic medium 660 for data storage. An exemplary holographic medium is the Tapestry™ medium developed by InPhase Technologies™.

The optical scanning device includes features of an optical device, capable of recording on and reading from a holographic medium 660, which is known from H. J. Coufal, D. Psaltis, G. T. Sincerbox (Eds.), ‘Holographic data storage’, Springer series in optical sciences, (2000), the contents of which is incorporated herein by way of reference.

The optical scanning device of FIG. 9 comprises a radiation source system 661 arranged to emit a radiation beam for irradiation of the holographic optical record carrier 659. The optical scanning device comprises a collimator 662, a movable first deflector 664, a first beam splitter 666, a first mirror 668, a spatial light modulator 670, a second beam splitter 672, a lens 674, the optical element 1 described previously using FIG. 1, a second lens 676, a third lens 678, a second mirror 680, a half wave plate 682, a third mirror 684, a second deflector 686, a telescope 688 and a detector 690. The optical scanning device is intended to record in and read data from the holographic medium 660.

During recording of a data page in the holographic medium 660, the first deflector 664 is moved out from the path emitted radiation beam, for example by mechanical movement as indicated by dashed lines in FIG. 9. A half of the radiation beam emitted by the radiation source 661 is sent towards the spatial light modulator 670 by means of the first beam splitter 666 and the first mirror 668. This portion of the radiation beam is called the signal beam. A half of the radiation beam emitted by the radiation source system 661 passes through the first beam splitter 666 and is redirected by the optical element 1 towards the holographic carrier 659, via the second and the third lenses 676, 678. This portion of the radiation beam is called the reference beam. The signal beam is spatially modulated by means of the spatial light modulator 670. The spatial light modulator comprises transmissive areas and absorbent areas, which corresponds to zero and one data-bits of a data page to be written. After the signal beam has passed through the spatial light modulator 670, it carries the signal to be written in the holographic medium 660, i.e. the data page to be written. The signal beam is then focused on the holographic medium 660 by means of the lens 674.

The reference beam is also focused on the holographic medium 660 by means of the second and third lenses 676, 678. The data page is thus written in the holographic medium 660, in the form of an interference pattern as a result of interference between the signal beam and the reference beam. Once a data page has been written in the holographic medium 660, another data page is written at a same location of the holographic medium 660. To this end, data corresponding to this data page is sent to the spatial light modulator 670. The control system 20 adjusts the fluid meniscus 16, so as to redirect the reference beam along a different output radiation beam path. In this way, the angle of the reference signal with respect to the holographic medium 660 is modified. An interference pattern is thus written with a different pattern at a same location of the holographic medium 660. This is called angle multiplexing. A same location, also termed a region, of the holographic medium 660 where a plurality of data pages is written is called a data book. The holographic medium 660 has at least one region for storing a data book. When scanning one region of the holographic medium 660, each of the plurality of output radiation beam paths for redirection of the reference beam corresponds with a different page of the data book in the one region. The second and third lenses 676, 678 are used to maintain that the redirected reference beam irradiates the same region of the medium 660 and therefore records data in the same region.

A minimum multiplex angle Δφ separating one data page and an immediately subsequent data page in the medium 660 is defined according to the following relationship 1:

$$Δ φ = \frac{λ cos ( {φ}_{s} )}{L sin ( {φ}_{r} + {φ}_{s} )} \qquad ( 1 )$$

where λ is the wavelength of the radiation beam; φₛ is the angle of incidence of the signal beam on the holographic medium 660 and φᵣ is the angle of incidence of the reference beam on the holographic medium 660, both angles taken with respect to an axis lying perpendicular a planar entrance face, for the beam, of the medium 660; and L is a thickness of the medium 660, in a direction perpendicular the plane of the entrance face. As an example, where λ=400 nm, L=0.5 mm, φₛ=0°, φᵣ=60° and ΔΦ=9.23×10⁻⁴ radians, a width of a Bragg peak is approximately 1 mrad. Preferably, a Bragg selectivity is chosen to be approximately 2 mrad to avoid cross talk between data pages. A maximum angular displacement range is approximately 20-30° which gives a range of a number of multiplex angles, corresponding to the number of data pages recordable in a book, of approximately 100-200.

During readout of a data page from the holographic medium 660, the first deflector 664 is moved into the path of the radiation beam emitted by the radiation source system 661 and deflects the beam so that the beam reaches the second deflector 686 via the second mirror 680, the half wave plate 682 and the third mirror 684. If angle multiplexing has been used for recording the data pages in the holographic medium 660, and a given data page is to be read out, the second deflector 686 is arranged in such a way that its angle with respect to the holographic medium 660 is the same as the angle that was used for recording this given hologram. The signal that is deflected by the second deflector 686 and focused in the holographic medium 660 by means of the telescope 688 is thus the phase conjugate of the reference signal that were used for recording this given hologram.

The phase conjugate of the reference signal is then diffracted by the information pattern of the data page, which creates a reconstructed signal beam, which then reaches the detector 690 via the lens 674 and the second beam splitter 672. An imaged data page is thus created on the detector 690, and detected by said detector 690. The detector 690 comprises pixels or detector elements, each detector element corresponding to a bit of the imaged data page. The spatial light modulator 670 is made completely absorbent, so that no portion of the beam can pass trough the spatial light modulator 670.

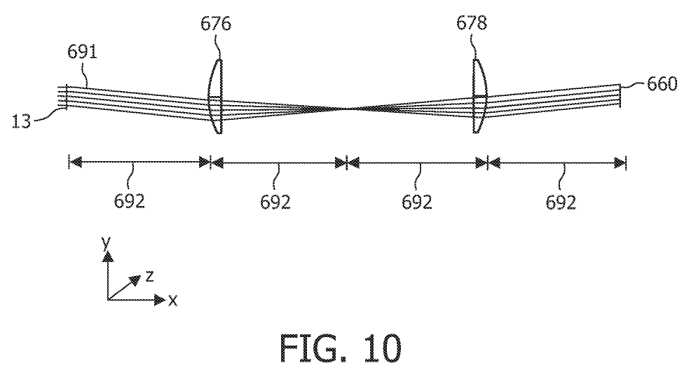

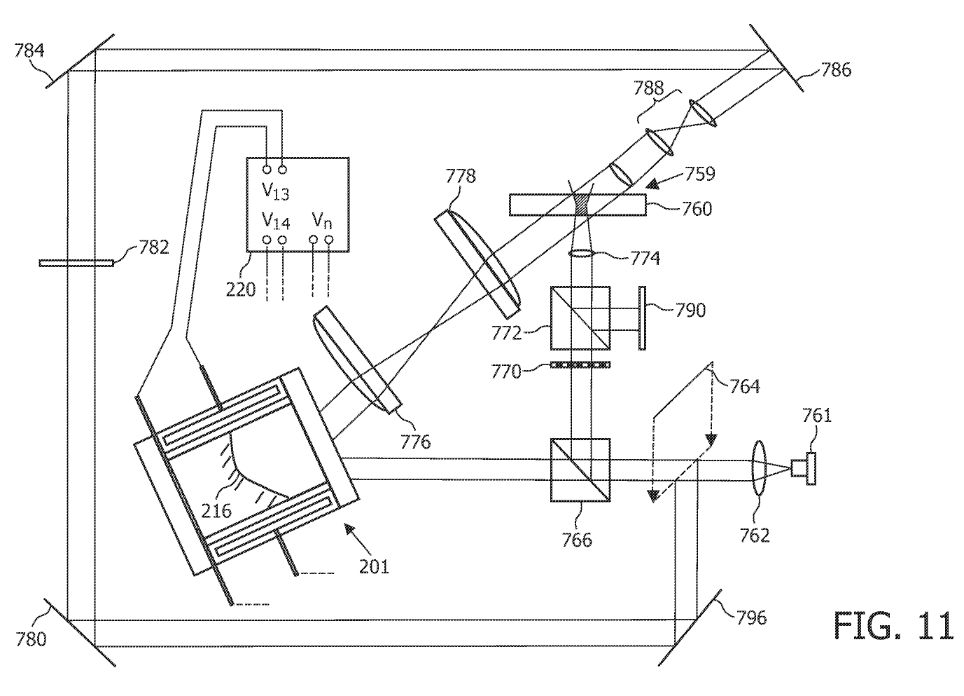

FIG. 10 shows, schematically, the passage of part 691 of the reference beam from the back element 13 of the optical element to the holographic medium 660, via the second and the third lenses 676, 678. In this embodiment, the second and third lenses 676, 678 each have a focal length of 79.86 mm, a lens thickness of 4.00 mm and are formed of BK7 glass. There is a certain distance 692 between the centre of the external surface of the back element 13 and the centre of the entrance face of the second lens 676. A distance between the centre of the exit face of the third lens 678 and the region of the holographic medium 660 being written to is of the same certain distance 692, and a distance between the centre of the entrance face of the second lens 676 and the centre of the exit face of the third lens 678 is double the certain distance 692. The radiation beam is inverted between the second and third lenses 676, 678.

In this embodiment, liquid A is oil having a refractive index of n=1.50 and liquid B is salted water having a refractive index of n=1.33. With a planar configuration of the meniscus 16, tilting the fluid meniscus 16 as a rotation about the z axis, as defined by orthogonal x, y, z axes, by an angle of 20° redirects the reference beam by an angle of 3.4° in a xy plane of the axes. Redirecting the beam in this way causes the reference beam to pass through the second and third lenses 676, 678 in a manner which introduces a 1.64 waves root mean squared (RMS) astigmatic wavefront aberration into the reference beam. This astigmatism would significantly reduce the scanning accuracy by the device of the holographic record carrier 659. For accurate scanning of the holographic medium 660, the beam preferably requires a maximum diffraction limit of 0.07 waves RMS wavefront aberration. Adjusting the fluid meniscus 16 to be a combination of the planar configuration and a cylindrical lens configuration, with a cylinder radius of −547.47 mm, the reference beam is still redirected by the angle of 3.4° and a second type of wavefront modification is also introduced into the reference beam, to compensate the astigmatism, so that the RMS astigmatic wavefront aberration of the reference beam is 0.007 waves.

In this way, the second type of wavefront modification is arranged to compensate a wavefront aberration of the radiation beam. The wavefront aberration may be at least one of astigmatism, spherical aberration and coma, and may be introduced into the radiation beam by the optical scanning device, by, for example, an adjustment of a beam redirection. In the described example, the astigmatism is introduced by the second and third lenses 676, 678 of the optical scanning device.

Redirection of the reference beam by the optical element, to record different data pages, causes the reference beam to pass through the second and third lenses 676, 678 along a different path. The second and third lenses 676, 678 introduce different wavefront aberrations into the reference beam when the reference beam is redirected along different output beam paths. The control system 20 adjusts the meniscus configuration so that the second type of wavefront modification compensates the introduced wavefront aberration which corresponds with the particular output radiation beam path that the beam is redirected onto. In this way, for different data pages which are written, the optical element adjusts the second type of wavefront modification in accordance with the corresponding angular displacement of the different output radiation beam paths of the redirected reference beam, so that each data page is written with a maximum accuracy.

It is envisaged that, in further embodiments of the present invention, the optical element 1 of the optical scanning device described with reference to FIG. 9, may alternatively be the optical element 101 described with reference to FIG. 4, or may be any optical element in accordance with the present invention which redirects the reference beam by refraction.

FIG. 11 shows an optical scanning device for scanning a holographic optical record carrier in accordance with a further embodiment of the present invention. FIG. 11 is not shown to scale. Features of the optical scanning device are similar to the device described using FIG. 9. The same reference numerals, incremented by 700 instead of 600, are used for such features and corresponding descriptions should be taken to apply here also.

In this embodiment the optical element 201 described using FIG. 5 is used to redirect the reference beam, instead of the optical element 1 shown in FIGS. 1 and 3. The optical scanning device writes to the holographic medium 760 in the same manner as described for FIG. 9. The optical device has a further mirror 796 which, during read-out of the holographic medium 760, reflects the radiation beam deflected by the first deflector 764 to the second mirror 780, and on to the holographic medium 760 as described previously.

It is envisaged that, in further embodiments of the present invention of the optical scanning device of FIG. 11, the optical element 201 may alternatively be the optical element 301 described with reference to FIG. 6, or may be any optical element in accordance with the present invention which redirects the reference beam by reflection.

The above embodiments are to be understood as illustrative examples of the invention. Further embodiments of the invention are envisaged. Holographic optical scanning devices have been described for angle multiplexing in combination with an amplitude multiplexing provided by the spatial light modulator. Shift multiplexing or phase-encoded multiplexing may be used instead of, or in combination with, amplitude multiplexing for recording data pages in the holographic medium.

Read-out of data from the holographic medium using the optical scanning devices illustrated using FIG. 9 or 11 takes place in a so-called conjugate mode. Alternative embodiments are envisaged where a beam for data read-out may not be deflected onto the medium by the deflector 686, 786, but may instead be redirected onto the holographic medium by the optical element. The beam acquires a read-out data signal from the medium and exits from a face of the carrier which is opposite the face through which the beam enters the carrier. In these embodiments, the exiting beam is focused by a lens onto a detector, similar to the detector described previously, where the lens and the detector are located on the same side of the holographic carrier as the face from which the data signal beam exits.

Various constructions of the optical element have been described, which can redirect the reference beam using refraction or reflection. Alternative constructions of the optical element are envisaged, in accordance with the scope of the invention. For example, any of the parts of the optical element may be transparent so that, for example, a radiation beam may enter the element via a segment electrode. Further, the liquid of any of fluids A, B, and/or C may be different to those described, and forces other than electrowetting forces may be used to adjust the meniscus configuration.

The positions of the input radiation beam path and/or the output radiation beam paths with respect to the optical element may be different to those described previously. Any position of these paths is envisaged which permits a radiation beam to enter the optical element and to subsequently exit the element along a redirected beam path.

The optical element has been described specifically for an optical scanning device for scanning a holographic optical record carrier; however, the optical element may be used in any optical scanning device. Moreover, the second type of wavefront modification is not limited to compensation of wavefront aberrations introduced by the optical scanning device. Compensation of a wavefront aberration introduced by an optical record carrier is envisaged.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical scanning device for scanning an optical record carrier, wherein said optical scanning device includes:
a) a radiation source system (661; 761) arranged to emit a radiation beam for irradiation of said optical record carrier;
b) an optical element (I; 101; 201; 301) comprising a first fluid (A) and a second fluid (B; C) separated from each other by a fluid meniscus (16; 116, 138; 216; 316) having an adjustable configuration; and
c) a control system (20; 120; 220; 320) arranged to adjust said fluid meniscus configuration to introduce a first type of wavefront modification, said first type of wavefront modification causing said radiation beam to be redirected from an input radiation beam path (2; 102; 244; 348) onto one of a plurality of output radiation beam paths (24, 26; 140; 246; 350) which each have a different angular displacement ( [symbol] ) from said input radiation beam path,
characterised in that said control system is further arranged to adjust said fluid meniscus configuration to introduce a second type of wavefront modification, said second type of wavefront modification being arranged to compensate a wavefront aberration of the radiation beam, the compensated wavefront aberration being adjusted in accordance with said angular displacement.

2. An optical scanning device according to claim 1, wherein the wavefront aberration includes at least one of astigmatism, spherical aberration and coma.

3. An optical scanning device according to claim 1, wherein said wavefront aberration is introduced into said radiation beam by said optical scanning device.

4. An optical scanning device according to claim 1, wherein said fluid meniscus is arranged to redirect said radiation beam by reflection or refraction.

5. An optical scanning device according to claim 1, wherein said optical element comprises a plurality of electrodes (6, 7, 8, 9, 18; 118, 136; 218; 318; 452; 554) and said control system is arranged to apply a voltage (V₁-V₁₆, Vₙ) to at least one of said plurality of electrodes to apply electrowetting forces to said fluids to determine said fluid meniscus configuration, wherein adjustment of said applied voltages adjusts said fluid meniscus configuration.

6. An optical scanning device according to claim 1, wherein said optical scanning device is arranged to scan a holographic optical record carrier (660; 760).

7. An optical scanning device according to claim 6, wherein said holographic record carrier has at least one region for storing a data book.

8. An optical scanning device according to claim 7, wherein each of said plurality of output radiation beam paths corresponds with a different data page of said data book.

9. An optical scanning device according to claim 7, wherein said optical scanning device is arranged so that said radiation beam irradiates the same region of said holographic optical record carrier when redirected along different of said plurality of output radiation beam paths.
